(19) United States
(12) Patent Application Publication
(10) Pub. No.: US 2016/0364781 A1
(43) Pub. Date: Dec. 15, 2016

(54) Commerce Recommendation System

(71) Applicant: NetDisruptors, LLC, Pompano Beach, FL (US)

(72) Inventor: Carlos Garcia, Lakewood Ranch, FL (US)

(21) Appl. No.: 15/099,808

(22) Filed: Apr. 15, 2016

Related U.S. Application Data
(60) Provisional application No. 62/148,069, filed on Apr. 15, 2015.

(51) Int. Cl. G06Q 30/06

(52) U.S. Cl. CPC G06Q 30/0631

(57) ABSTRACT

In a commerce server device, a method for providing a commerce recommendation message includes receiving, by the commerce server device, at least one behavior event indicator from a user device, the at least one behavior event indicator having an event trigger identifier, a commerce item associated with the event trigger identifier, and a value criterion associated with the event trigger identifier. The method includes comparing, by the commerce server device, the value criterion associated with the event trigger identifier with a threshold value. The method includes, when the value criterion associated with the event trigger identifier meets the threshold value, identifying, by the commerce server device, the commerce item associated with the event trigger. The method includes transmitting, by the commerce server device, the commerce recommendation message to the user device, the commerce recommendation message being associated with the identified commerce item.

### RELATED APPLICATIONS

This patent application claims the benefit of U.S. Provisional Application No. 62/148,069, filed on Apr. 15, 2015, entitled, “Commerce Recommendation System,” the contents and teachings of which are hereby incorporated by reference in their entirety.

### BACKGROUND

With the development of the Internet, users have been able to purchase goods from individuals and merchants in a variety of ways. In one arrangement, a user typically utilizes the Internet to research a product prior to making the purchase. For example, the user may search for the product by entering various search terms into a web browser to find a retailer that sells the goods of interest. In another arrangement, a user can purchase goods using a number of forums or commerce sites, such as EBAY and Craigslist. During a purchasing process, the user utilizes the search functionality of the commerce sites to research and purchase a product.

### SUMMARY

In conventional commerce sites, it is difficult for merchants to detect or track the items that a user may purchase and notify the user of related goods.

By contrast to conventional commerce sites, embodiments of the present innovation relate to a commerce recommendation system. In one arrangement, a server device is configured to provide user devices with product information regarding products for sale within the commerce recommendation system. In response to detecting user device activities associated with the product information, such as information regarding products searched, approved, watched, or purchased through the commerce recommendation system, the server device is configured to collect commerce behavior information from the user device. Based upon the collected commerce behavior information, the server device is configured to provide commerce recommendation message to the user device. For example, based upon a user's interest in tablet devices, as indicated by the commerce behavior information, the server device is configured to provide recommendation messages for products which are related to tablet devices, such as tablet cases, chargers, or headphones. Accordingly, embodiments of the commerce recommendation system allow merchants to provide advertisement for related goods to a user in a timely and effective manner in order to increase the probability of conversion (e.g., the probability that the commerce recommendation message will result in a sale of the product introduced by the commerce recommendation message).

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic representation of a commerce recommendation system, according to one embodiment.

FIG. 2 illustrates a user device of the commerce recommendation system of FIG. 1 displaying product information, according to one arrangement.

FIG. 3A illustrates the user device of the commerce recommendation system of FIG. 1 displaying categories of product information, according to one arrangement.

FIG. 3B illustrates the user device of the commerce recommendation system of FIG. 1 displaying a selected category of product information, according to one arrangement.

FIG. 4A illustrates the user device of the commerce recommendation system of FIG. 1 displaying product information as part of a newsfeed, according to one arrangement.

FIG. 4B illustrates the user device of the commerce recommendation system of FIG. 1 displaying product information selected from the newsfeed, according to one arrangement.

FIG. 5A illustrates the user device of the commerce recommendation system of FIG. 1 displaying an offer indicator and a purchase indicator of a product for sale, according to one arrangement.

FIG. 5B illustrates the user device of the commerce recommendation system of FIG. 1 displaying an offer request in response to selection of the offer indicator, according to one arrangement.

FIG. 6 illustrates an example of the server device of FIG. 1 having a profile database, according to one arrangement.

FIG. 7 illustrates an example of an effective cost per thousand (eCPM) chart, according to one arrangement.

FIG. 8 illustrates a distribution of a conversion rate for a commerce recommendation message by frequency, according to one arrangement.

### DETAILED DESCRIPTION

Embodiments of the present innovation relate to a commerce recommendation system. In one arrangement, a server device is configured to provide user devices with product information regarding products for sale within the commerce recommendation system. In response to detecting user device activities associated with the product information, the server device is configured to collect commerce behavior information from the user device. For example, the server device is configured to collect information regarding products searched, approved, watched, or purchased through the commerce recommendation system. Based upon the collected commerce behavior information, the server device is configured to provide product recommendation messages to the user device. For example, based upon a user's interest in tablet devices, as indicated by the commerce behavior information, the server device is configured to provide recommendation messages for products which are related to tablet devices, such as tablet cases, chargers, or headphones. Accordingly, embodiments of the commerce recommendation system allow merchants to provide advertisement for related goods to a user in a timely and effective manner.

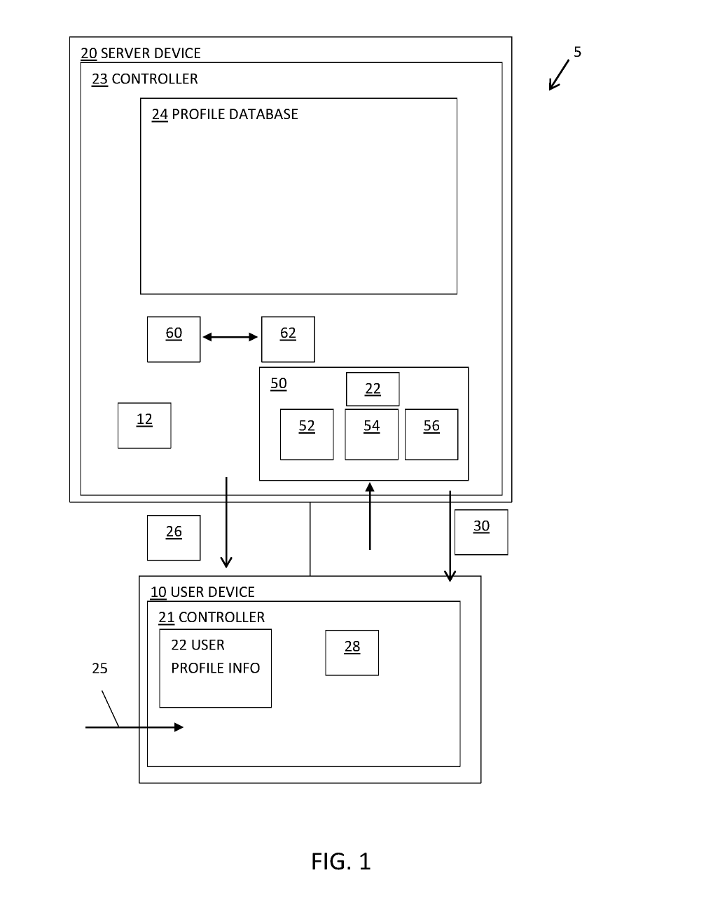

FIG. 1 illustrates an example schematic representation of a commerce recommendation system 5, according to one arrangement. The commerce recommendation system 5 includes one or more user devices 10 disposed in electrical communication with a server device 20. For ease of description, a single user device 10 is shown and described.

The user device 10 is configured as a computerized device such as a mobile phone (e.g., smartphone), a tablet device, a laptop computer, or other computerized device. The user device 10 includes a controller 21, such as a memory and a processor. While the user device 10 can be disposed in electrical communication with the server device 20 in a variety of ways, in one arrangement the user device 10 and server device 20 exchange communication via a wireless network, such as a wide area network (WAN).

In one arrangement, the commerce recommendation system 5 is configured as a subscription service. For example, in order for a user device 10 to access the server device 20 to receive product information, the user initially establishes an account with the server device 20, such as via the user device 10. As part of the subscription, the user device 10 transmits user profile information 22 to the server device 20. While the user profile information 22 can be configured in a variety of ways, in one arrangement the user profile information 22 can include personal information such as user name, address, mobile phone number, mobile phone identification information, email address information, credit card information, and/or social media information, as well as demographic information, such as user age, gender, employment, income, education, ethnicity, and/or marital status information. Once received, the server device 22 stores the profile information 22 from each user device 10 in a profile database 24.

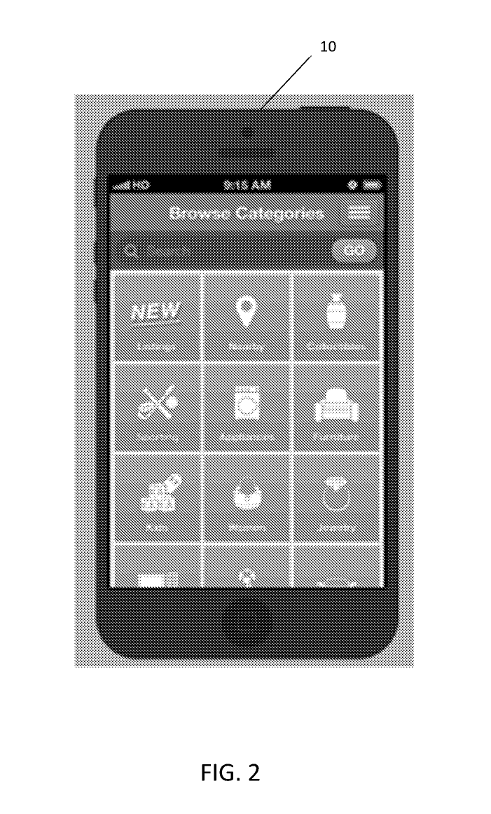

The user device 10 is configured to receive product information 26 associated with items for sale through the commerce recommendation system 5 from the server device 20. In one arrangement, the user device 10 (i.e., the memory and controller of the user device 10) is configured to execute a product identification application 28 which configures the user device 10 to receive product information 26 from the server device 20. For example, with reference to FIG. 2, when executing the product identification application 28, the user device 10 can receive the product information 26 from the server device 20 as a listing of products by category. The user device 10 is configured to display the product information 26 to a user via a display, such as a touchscreen display. As will be described below, the user can utilize the user device 10 to exchange messages with the server device 20 to receive additional information regarding the products for sale by other users of the commerce recommendation system 5.

The server device 20 is configured as a computerized device which includes a controller 23, such as a memory and a processor. The server device 20 is configured to provide the user device 10 with product information 26 associated with items for sale by users of the commerce system 5. For example, the server device 20 stores product listing information received from a variety of users and/or merchants as part of a product database 12. The server device 20 is configured to provide the product information 26 to the user device 10 via the product identification application 28 executed by the user device 10.

In one arrangement, the server device 20 is configured to detect commerce behavior associated with the user device 10 based upon a user's interaction with the user device 10. For example, as the user interacts with the user device 10 with respect to particular products available within the commerce recommendation system 5, the user device 10 generates corresponding event triggers 25.

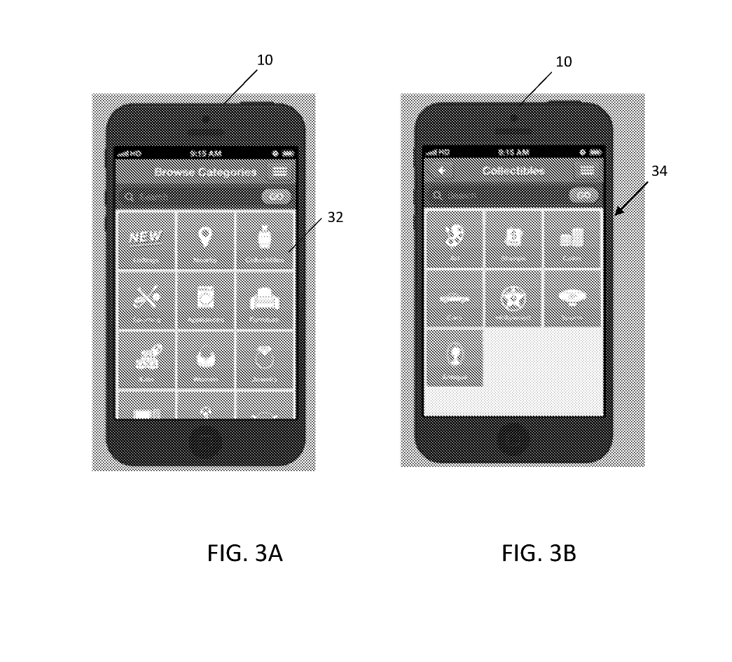

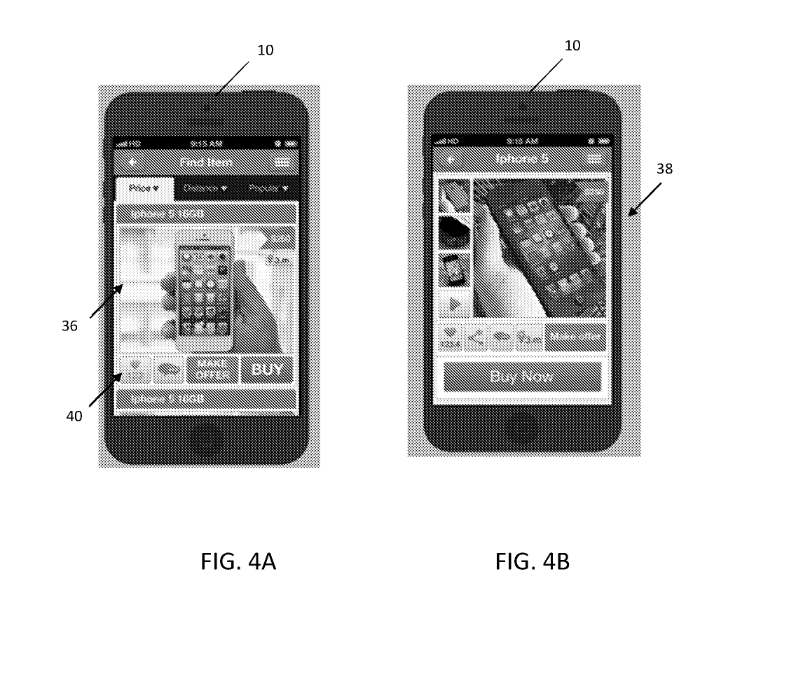

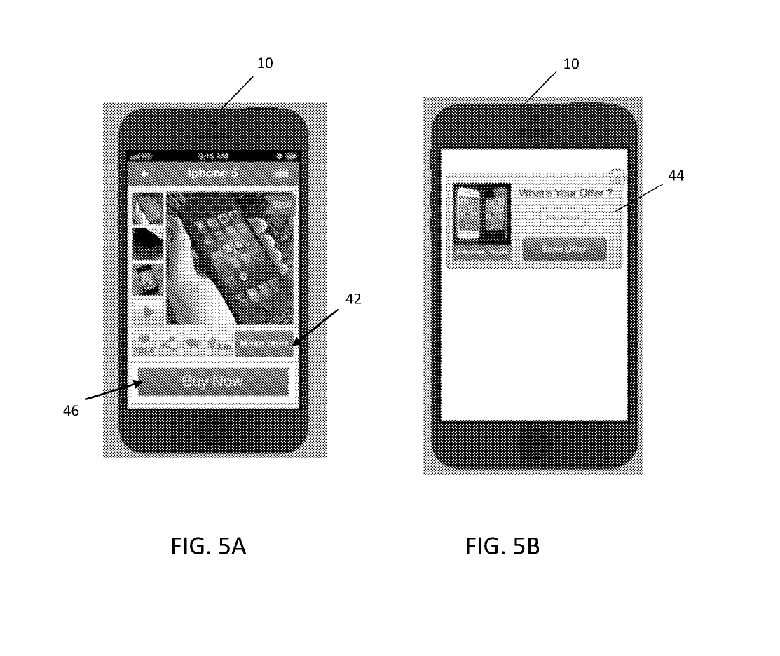

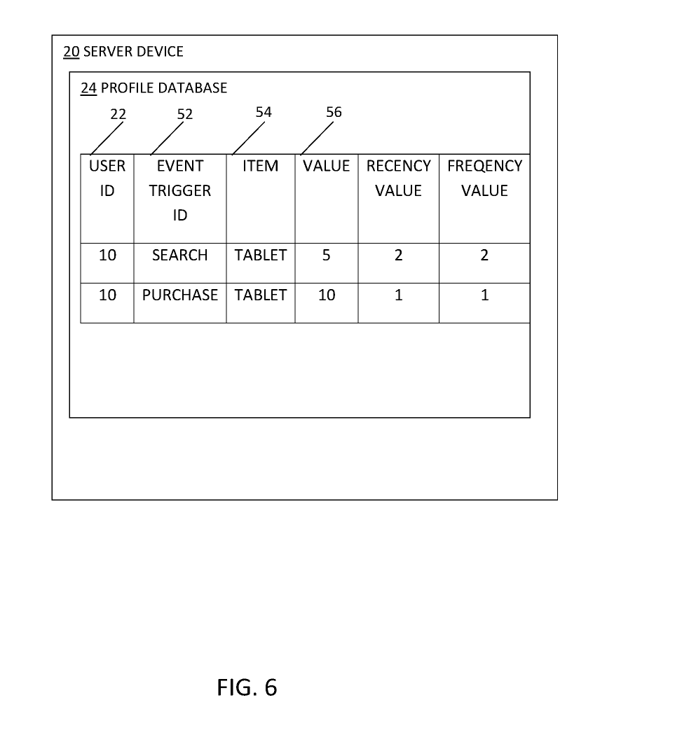

For example, as shown in FIG. 3A, the user device 10 can display product information 26 from the server device 20 as a listing of products by category. As an event trigger 25, the user can select a particular category 32, such as “collectables” to receive additional information 34 on the selected category, as shown in FIG. 3B. In other examples of event triggers 25, the user can utilize the user device 10 to search for products for sale using search terms or to add products for sale to a watch list (not shown). In another example of an event trigger 25, the user can tap on an image of an item on the user device 10 as provided to the user in a newsfeed 36, as illustrated in FIG. 4A, to obtain details on the item listing 38, as shown in FIG. 4B. In another example of an event trigger 25, the user can show interest in an item by tapping on a like image 40 on the user device 10, as shown in FIG. 4A. In another example of an event trigger 25, the user can tap an image of an offer indicator 42, as illustrated in FIG. 5A, to make an offer 44 for an item for sale, as shown in FIG. 5B. In another example of an event trigger 25, the user can tap an image of a purchase indicator 46 to purchase an item for sale, as shown in FIG. 5A.

As the user utilizes the user device 10 to search for products (e.g., such as via keyword searching), to add products to a watch list, or to purchase products, the user device 10 generates event triggers 25. In response to creating event triggers 25, the user device 10 is configured to generate corresponding behavior event indicators 50 associated with the user and to transmit the behavior event indicators 50 to the server device 20. The behavior event indicators 50 identify the user's interest in particular types of products for sale through the commerce system 5 based upon the user's interaction with the user device 10.

The behavior event indicator 50 can be configured in a variety of ways. In one arrangement, with reference to FIG. 1, the behavior event indicator 50 can include user profile information 22 along with an event trigger identifier 52, a commerce item identifier 54, and a value criterion 56 associated with the event trigger identifier 52.

The event trigger identifier 52 indicates a particular event trigger 25 generated by the user in his interaction with the user device 10. For example, the event trigger identifier 52 can indicate whether the user was searching for an item, adding an item to a watch list, approving or liking an item, searching for a particular category of an item, tapping an image of an item provided on a newsfeed, making an offer on an item, or purchasing an item using the user device 10. The commerce item identifier 54, in one arrangement, provides a listing of the item associated with the event trigger identifier 52. For example, assume the case where a user utilized the user device 10 to add a tablet device for sale within the commerce network 5 to a watch list. In this case, the event trigger identifier 52 indicates that the user utilized the watch list functionality of the user device 10 while the commerce item identifier 54 indicates that the user is interested in a tablet device.

As indicated above, the behavior event indicator 50 includes a value criterion 56 associated with the event trigger 25. For example, each event trigger 25 is configured with an associated value criterion 56, such as a preset number of points. When a user engage a particular event trigger 25, the user device 10 includes the point value associated with the event trigger 25 as part of the behavior event indicator 50. In one arrangement, each of the event triggers 25 can be configured with identical value criterion 56, such as a value of five points. In one arrangement, each of the event triggers 25 can be configured with different value criteria 56, such as provided below:
Search Terms=5 Points
Watch List (User Adds Item to Watch List)=10 Points
Likes (User approves of an item)=10 Points
Category (User taps/searches for items in category)=5 Points
Tapped (When a user taps on a displayed item to get the details on an item)=5 Points
Offers (When a user makes an offer on an item)=10 Points
Purchased (When a user purchases an item)=15 Points

In one arrangement, the behavior event indicator 50 is configured to identify additional information regarding a user's commerce behavior via the user device 10. For example, the behavior event indicator 50 can identify recency information related to each of the event triggers 25.

In one arrangement, recency information is configured as a value or score that indicates a length of time from when the user engaged a particular event trigger 25. For example, assume a user utilizes the user device 10 on Day 1 to search for a tablet device within the commerce recommendation system 5. The user device 10 can assign the Day 1 recency information a first score (e.g., a score of 5 on a scale of 1 to 10) to indicate that the event trigger 25 occurred as a relatively recent event and can provide the score as a recency value criterion in a first commerce behavior identifier 50. If the user utilizes the user device 10 on Day 2 to search for a tablet device, the user device 10 can increase the recency score (e.g., a score of 9 on a scale of 1 to 10) to indicate that the event trigger 25 occurred as a more recent event. The user device 10 can include the increased recency score as a recency value criterion in a second commerce behavior identifier 50 provided to the server device 20.

As indicated above, the behavior event indicator 50 is configured to identify additional information regarding a user's commerce behavior via the user device 10. For example, the behavior event indicator 50 can identify frequency information related to each of the event triggers 25.

In one arrangement, frequency information is configured as a value or score that indicates the number of times that a user has engaged a particular event trigger 25. For example, assume a user utilizes the user device 10 on to search for a tablet device within the commerce recommendation system 5 a total of five times on Day 1 and ten times on Day 2. Based upon the number of times the event trigger 25 (e.g., the product search) was engaged, the user device 10 can assign the frequency information a relatively moderately score on Day 1 (e.g., a score of 5 on a scale of 1 to 10) and a relatively high score on Day 2 (e.g., a score of 8 on a scale of 1 to 10). The user device 10 can provide these scores as frequency value criteria as part of corresponding commerce behavior identifiers 50.

The frequency information can also be configured to identify the time of at which the user device 10 accesses the product information 26. For example, assume the user device 10 accesses the commerce recommendation system 5 on Day 1 through Day 5 between the hours of 12:00 PM and 1:00 PM. The frequency information can identify this timeframe as being a high use or frequent use timeframe associated with the user device 10.

As the user device 10 generates behavior event indicators 50 based upon the user's commerce behavior (e.g., searching for a product, adding a product to a watch list, etc.), the user device 10 transmits the behavior event indicators 50 to the server device 20 in real time. The server device 20, in turn, identifies the source of the behavior event indicator 50, such as via the user profile information 22, and updates a corresponding user device entry in the profile database 24.

In response to reception of one or more behavior event indicators 50, the server device 20 is configured to provide a selected commerce recommendation message 30 to the user device 10. In one arrangement, the commerce recommendation message 30 can provide the user with information about products available for sale through the commerce system 5 which are related to particular event triggers 25 generated by the behavior of the user.

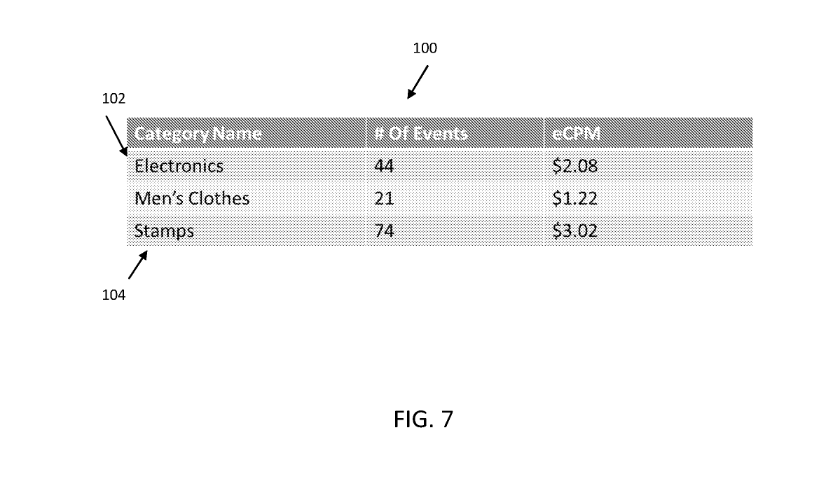

In one arrangement, prior to selecting a commerce recommendation message 30, the server device 20 is configured to aggregate the value criterion 56, recency value criterion, and frequency value criterion of one or more behavior event indicators 50 for a particular user device 10 and for a particular product, such as identified by the commerce item identifier 54. For example, with reference to FIG. 7, assume the case where the server device 20 receives a first behavior event indicator 50-1 from the user device 10 which lists a first event trigger identifier 52-1 as being a word search, the commerce item 54-1 as being a tablet, the associated value criterion 56 having a value of 5, the recency value criterion having a value of 5, and the frequency value criterion having a value of 2. Further assume the case where the server device 20 receives a second behavior event indicator 50-2 from the user device 10 which lists a second event trigger identifier 52-1 as being a purchase, the commerce item 54-2 as being a tablet, the associated value criterion 56 having a value of 10, the recency value criterion having a value of 1, and the frequency value criterion having a value of 1. For the same user device 10 and the same commerce item (i.e., the tablet), the server device 20 can sum the value criteria (i.e., the value criteria for the first and second behavior event indicators 50-1, 50-2) to arrive at a final criterion value 60 of 21.

Next, returning to FIG. 1, the server device 20 is configured to compare the value criterion 60 associated with the event trigger identifier 50 with a threshold value 62. In the case where the value criterion 60 associated with the event trigger 50 identifier meets or exceeds the threshold value 62, the server device 20 is configured to transmit the commerce recommendation message 30 to the user device 10 where the commerce recommendation message 30 is associated with the identified commerce item.

For example, assume the case where the threshold value 62 is equal to 20. In such a case the comparison of the threshold value to the final criterion value 60 of 21 results in the final criterion value 60 exceeding the threshold value 62. In such a case, the server device 20 is configured to transmit a commerce recommendation message 30 to the user device 10 where the commerce recommendation message 30 relates to the identified commerce item, i.e. the tablet device. For example, the server device 20 can transmit a commerce recommendation message 30 identifying a tablet case or tablet power charger to the user device 10 for display to the user.

In such an arrangement, the server device 20 is configured to review the profile database 24 for users and products having the highest amount of criterion points and provide a commerce recommendation message 30 that best suits the user device 10 profile.

In one arrangement, the server device 20 is configured to distribute commerce recommendation message 30 based upon effective cost per thousand (eCPM) data where eCPM is defined as the amount earned by an advertisement divided by the total number of advertisement impressions or views. For example, as user devices 10 interact with the commerce recommendation system 5, the server device 20 calculates eCPM data for each product, as identified by the commerce item identifier 54, offered within the commerce recommendation system 5.

With reference to the example chart 100 of FIG. 7, based upon the data collected in the profile database 24, the server device is configured to calculate the eCPM for each category of products. For example, the category of electronic products 102 has an eCPM of $2.08 while the category of stamps 104 has an eCPM of $3.02. Because the stamps category 104 has a larger eCPM value than the electronics category 102, for a user device 10 that accesses the commerce recommendation system 5 regarding stamps and electronics, the server device 20 is configured to transmit a commerce recommendation message 30 related to stamps to the user device 10 before sending the user device 10 a commerce recommendation message 30 that relates to electronics devices. With such a configuration, the server device 20 can optimize the response rate and revenue for a set of advertisements.

In one arrangement, the server device 20 is configured to transmit commerce recommendation message 30 to the user device 10 based upon eCPM data after a user has utilized the user device to purchase a product through the commerce recommendation system 5.

For example, with reference to FIG. 3A, assume the case where a user utilizes a user device 10 to browse for collectables 32, such as baseball cards and artwork. Further assume the case where the user searches for baseball cards more frequently than artwork. In this case, because the frequency criterion associated with baseball card searches is higher than the frequency criterion associated with artwork searches, the server device 20 is configured to transmit a commerce recommendation message 30 associated with baseball cards to the user device 10.

In one arrangement, in the case where the server device 20 detects a purchase event for an item sold through the commerce recommendation system 5, the server device 20 is configured to compare the eCPM value for the recently purchase item versus the eCPM value for an earlier purchased item. In the case where the eCPM value for the recently purchase item is larger than the eCPM value for an earlier purchased item, the server device 20 is configured to transmit commerce recommendation messages 30 based upon the recently purchased item. For example, assume the case where the user purchases a piece of art with a relatively high value using the user device 10. In such a case, the eCPM for the artwork is higher than the eCPM for the baseball cards. Based upon a comparison of the eCPM for the artwork (recent purchase) versus the eCPM for the baseball cards (earlier purchase), the server device 20 can detect the eCPM of the artwork as being higher than the eCPM for the baseball cards. As a result, the server device 20 is configured to transmit a commerce recommendation message 30 associated with artwork to the user device 10.

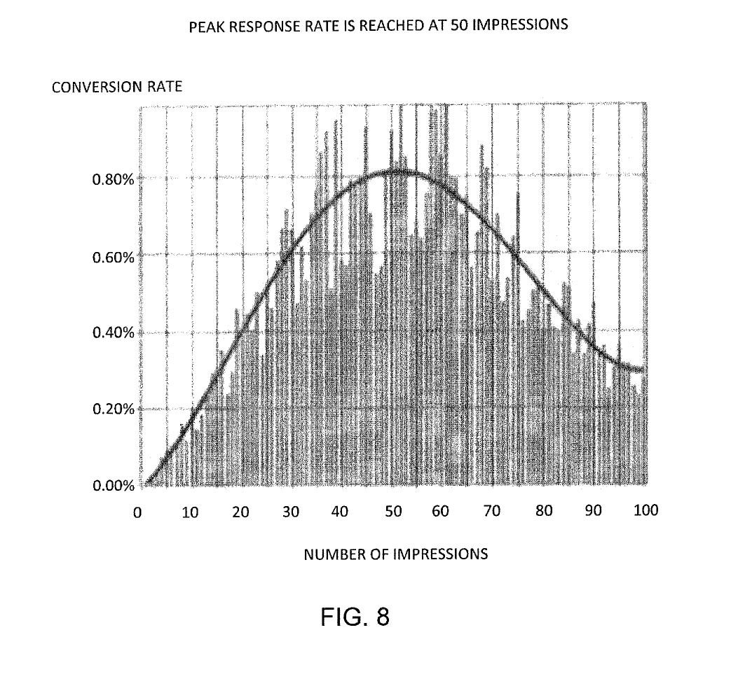

In one arrangement, based upon the behavior event indicators 50, the server device 20 is configured to transmit the commerce recommendation message 30 to the user device 10 at a selected frequency (e.g., number of impressions shown to a user) based upon an aggregate of the data in the profile database 24. FIG. 8 illustrates an example distribution of the conversion rate vs. frequency for a given commerce recommendation message 30.

While various embodiments of the innovation have been particularly shown and described, it will be understood by those skilled in the art that various changes in form and details may be made therein without departing from the spirit and scope of the innovation as defined by the appended claims.

For example, as described above, the server device 20 is configured to receive the value criterion, recency value criterion, and frequency value criterion from the user device 10. Such description is by way of example only. In one arrangement, the server device 20 is configured to assign any or all of the value criterion, recency value criterion, and frequency value criterion to a behavior event indicator 50 received from the user device 10.

As indicated above, prior to transmitting a commerce recommendation message 30 to the user device 10, the server device 20 is configured to compare a value criterion 60 associated with the event trigger identifier 50 with a threshold value 62. In the case where the value criterion 60 associated with the event trigger 50 identifier meets or exceeds the threshold value 62, the server device 20 transmits the commerce recommendation message 30. Such description is by way of example only. In one arrangement, the server device 20 is configured to review the user profile information 22, including personal information and demographic information, associated with the user device 10 prior to transmitting the commerce recommendation message 30. Such a review allows the server device 20 to deliver the commerce recommendation message 30 to specific user devices 10 to increase the probability of conversion (e.g., the probability that the commerce recommendation message 30 will result in a sale of the product advertised by the commerce recommendation message 30).

As indicated above, prior to selecting a commerce recommendation message 30, the server device 20 is configured to aggregate the value criterion 56, recency value criterion, and frequency value criterion of one or more behavior event indicators 50 for a particular user device 10 and for a particular product, such as identified by the commerce item identifier 54. Such indication is by way of example only. In one arrangement, the server device 20 is configured to aggregate the data stored in the profile database in a variety of ways. For example, data can be aggregated by product category, as indicated in FIG. 7, by user, or by a component of the user profiles 22 (e.g., gender, income, etc.) stored in the profile database 24.

What is claimed is:

1. In a commerce server device, a method for providing a commerce recommendation message, comprising:
receiving, by the commerce server device, at least one behavior event indicator from a user device, the at least one behavior event indicator having an event trigger identifier, a commerce item associated with the event trigger identifier, and a value criterion associated with the event trigger identifier;
comparing, by the commerce server device, the value criterion associated with the event trigger identifier with a threshold value; and
when the value criterion associated with the event trigger identifier meets the threshold value, transmitting, by the commerce server device, the commerce recommendation message to the user device, the commerce recommendation message being associated with the identified commerce item.

2. The method of claim 1, wherein the event trigger identifier comprises a commerce item search term indicator.

3. The method of claim 1, wherein the event trigger identifier comprises a commerce item watch list indicator.

4. The method of claim 1, wherein the event trigger identifier comprises a commerce item approval indicator.

5. The method of claim 1, wherein the event trigger identifier comprises a commerce item category indicator.

6. The method of claim 1, wherein the event trigger identifier comprises a commerce item detail request indicator.

7. The method of claim 1, wherein the event trigger identifier comprises a commerce item offer indicator.

8. The method of claim 1, wherein the event trigger identifier comprises a commerce item purchase indicator.

9. The method of claim 1, wherein the at least one behavior event indicator further comprises a recency indicator and a recency value criterion, the recency indicator configured to identify a time at which at least one behavior event indicator was generated.

10. The method of claim 1, wherein the at least one behavior event indicator further comprises a frequency indicator and a frequency value criterion, the frequency indicator corresponding to a number of times the at least one behavior event indicator was generated.

11. The method of claim 1, further comprising:
detecting, by the commerce server device, a purchase event;
transmitting, by the commerce server device, the commerce recommendation message to the user device, the commerce recommendation message based upon an eCPM value.
